(19) United States
(12) Patent Application Publication
(10) Pub. No.: US 2006/0138170 A1
(43) Pub. Date: Jun. 29, 2006

(54) Systems and methods for dispensing fluid

(76) Inventors: Eric Brim, Ruckersville, VA (US); Scott Tindall, Richmond, VA (US); Michael F. Kalanick JR., Stratford, CT (US)

Correspondence Address: LATIMER IP LAW, LLP, 13873 PARK CENTER ROAD, SUITE 122, HERNDON, VA, 20171, US

(21) Appl. No.: 11/280,813

(22) Filed: Nov. 17, 2005

Related U.S. Application Data
(60) Provisional application No. 60/628,775, filed on Nov. 18, 2004.

(51) Int. Cl. B67D 5/56

(52) U.S. Cl. 222/129.1

(57) ABSTRACT

The present invention provides an automatic mixing and dispensing device that includes a plurality of storage reservoirs for various liquids interposed between a source of pressurized gas and a mixing and dispensing unit. The device further includes a final receiving area into which the liquids can be dispensed. The invention also provides a method for storing and delivering fluids to a centralized mixing and dispensing unit, which can include dispensing a mixed beverage to a final container, such as a cup. The method includes applying pressure to a reservoir tank holding a desired liquid, thus forcing the liquid from the tank into the mixing and dispensing unit. The amount of time that the pressure is applied to the reservoir tank correlates to a specific amount of volume delivered. The method can be accomplished using a computer.

### CROSS-REFERENCE TO RELATED APPLICATIONS

This application relies on and claims the benefit of the filing date of U.S. Provisional patent application No. 60/628,775, filed 18 November 2004, the entire disclosure of which is hereby incorporated herein by reference.

### BACKGROUND OF THE INVENTION

1. Field of the Invention

The present invention relates to the field of dispensing of fluids. More specifically, it relates to systems and devices that mix and dispense multiple fluids based on pre-set recipes.

2. Discussion of Related Art

Automated mixing and dispensing machines have been proposed as a solution to various problems encountered in the food and drink industry. For example, they have been proposed as a solution to wasteful and inaccurate dispensing of alcohol in bars and other establishments that serve alcoholic drinks. They have also been proposed as a solution to inconsistencies in mixing of various drinks from establishment to establishment, and to the time and human labor required to prepare and serve beverages, such as carbonated soft drinks and mixed drinks.

Conventional automated mixing and dispensing machines may be divided into two general classes: gravity assisted machines and pressure assisted machines. Gravity assisted mixing and dispensing machines typically use the force of gravity to drive liquids to a mixing chamber, from which they are delivered, using the force of gravity, to a final container for the mixture, such as a cup for a beverage. In contrast, pressure assisted mixing and dispensing machines typically use a pressurized gas to expel the liquids to be mixed into a mixing chamber or directly into a final container for the mixture.

Such conventional automated mixing and dispensing machines suffer from various shortcomings. For example, the machines utilizing gravity to deliver the liquids require that the liquids be stored at a location that is higher than the dispensing head. Such a requirement limits the volume of liquid that can be stored for immediate use in the machine, and limits the design of the machine to one that includes enough space to accommodate the desired number of liquids to be dispensed. Alternatively, the machines utilizing compressed gas to deliver liquids have numerous valves and solenoids, each of which being prone to crystallization from exposure to fluids, or other failure. In addition, it is difficult, time-consuming and costly to clean the internal working parts of such types of conventional machines.

For example, U.S. Pat. No. 6,375,043 discloses a drink machine that relies on gravity to dispense pre-determined amounts of liquids to create a complete mixed drink. Tanks containing the available liquids are located above the dispenser and are connected to the dispenser by lines. A single computer-controlled solenoid per tank of liquid is used to dispense pre-determined amounts of liquid, the amounts being determined based on the recipe contained in the computer. The computer calculates the amount of time required for the solenoid to be open in order to dispense the proper amount of liquid, taking into account the amount of liquid remaining in each tank of liquid.

Likewise, U.S. Pat. No. 6,607,013 discloses an automatic bar for dispensing mixed and non-mixed drinks. This patent discloses that liquids from bottles placed above the dispenser are permitted to drain into a final container. The amount of liquid dispensed into the final container is controlled by an automatic dosing valve with a magnetic actuator.

U.S. Pat. No. 6,332,559 discloses a liquor dispensing apparatus that uses pressurized air to deliver metered amounts of liquids. This patent discloses the use of a pneumatic pump to pump liquor into a metering reservoir, where an amount of liquor is delivered through the opening and closing of a solenoid. A pre-determined amount of the liquor in the metering reservoir is delivered to a final container through air pressure supplied by the opening of a solenoid, which causes the liquor in the metering reservoir to exit the reservoir when a third solenoid opens.

A complex automatic drink dispensing apparatus is disclosed in U.S. Pat. No. 3,991,911. This apparatus is disclosed as being capable of automatically dispensing beverages, such as mixed drinks, using the force of gravity, compressed air, pressurized water, carbonation pressure, or a combination of these. The apparatus maintains all liquids separate from each other until they are in the atmosphere between the pour head and the receptacle into which they are being dispensed. Numerous solenoids are used to control the amount of liquid dispensed, with at least one solenoid controlling the pressure used to deliver the liquid and at least one solenoid controlling the amount of liquid delivered.

Thus, a need exists in the art to provide an automated mixing and dispensing apparatus that is simple in design, avoids the need for gravity assistance to mix and deliver liquids, is easily and quickly cleaned, minimizes costs, and does not suffer from a high rate of breakdowns.

### SUMMARY OF THE INVENTION

The present invention provides systems and methods for automatic mixing and distributing of fluids. This includes a method of storing and delivering fluids to a centralized mixing and dispensing apparatus such that the final fluid combination is dispensed into a removable container. The storage reservoirs preferably use a supply gas to create a pressure inside the reservoir to push the fluid to the mixing and dispensing apparatus for a specific amount of time. The amount of time and applied gas pressure correlate to a specific amount of volume of dispensed fluid. Preferably, a control circuit with an embedded processor controls the time and flow characteristics. The device provides consistent mixing and quick distributing of fluid combinations, close accounts of reservoir inventory, reduction of waste, and reduction of labor at an attractive cost.

The present invention relates generally to a mixing and dispensing mechanism. In one exemplary embodiment, the present invention pertains to the alcohol industry, specifically producing and distributing alcoholic drinks, even though it is not limited to this industry. The systems and methods according to the present invention may be applied to any other industry that could benefit from an automated mixing and dispensing systems and methods. In other words, the exemplary mixing and dispensing systems and methods according to the present have residential and commercial purposes. The residential apparatus may dispense a combination of fluids, such as organic alcohols, liquor, spirits, juices, and carbonated beverages, as a command from the user. In a commercial environment, the apparatus performs the same function, and keeps track of volumes of fluids dispensed. This type of apparatus creates close control over volumes of fluids the apparatus combines into drinks. The reduction in alcoholic waste or elimination of inconsistencies from the professionals is a potentially large economic gain. Another advantage of the present invention is the simple ability to track government monitored substances. This is a benefit to comply with government regulations around distributing alcohol. The ability to produce a volume of high-quality beverages with ease is important for commercial and economical success of the present invention. For example, if a bar makes a particularly popular drink, then that drink may be consistently made by programming the device with a proper combination of mixtures.

An exemplary embodiment comprises a set of reservoirs, with each reservoir containing a single valve on the pressurizing fluid side. This embodiment uses pressure versus time relationships to control volume flow as opposed to use of multiple valves per reservoir. This exemplary embodiment is just as effective as conventional systems, but without the additional costs for the extra mechanical elements. Also, by not having the discharge fluid come into contact with the valve mechanism, there is a decreased risk of contaminating the valves, thereby reducing health and mechanical difficulties. The advantage of the reduction and simplifying of the number of valves makes exemplary embodiments of the present invention cheaper, just as efficient, and easier to maintain. This argument applies to all conventional systems and methods with fluid being pumped by pressure.

In a broad sense, the present invention provides a system for mixing and distributing fluids. In one application of the present invention, the fluids are consumable, mass-producible fluids, such as organic alcohols, liquors, spirits, and any fluid that can be mixed with the consumable alcohols, liquors, and spirits, such as water (plain or carbonated), juices, and sodas. In this particular application, the present invention provides mixing and distributing of the fluids in order to produce a final beverage selected by the user.

The plurality of reservoirs, in accordance with an exemplary embodiment of the present invention, includes cylindrical tubes. The tubes are large enough in diameter and height to hold a specific amount of fluid. The cylinders are preferably made of stainless steel. In other aspects, the shape of the reservoir is not restricted to a cylinder, and can have a cross-section represented by any geometric shape, such as a square, rectangle, triangle, pentagon, hexagon, octagon, oval, ellipse, etc. Preferably, the reservoir is generally cylindrical to aid in cleaning. Preferably, the reservoir has a bottom surface that is generally conical to aid in removal of small volumes of liquid from the reservoir. The reservoirs can be made of any material that is able to withstand the pressure exerted upon it by the system without causing expansion or being altered or altering the fluid stored in the reservoir. Exemplary materials include, but are not limited to, plastic, glass, and other metals, or combinations thereof. In the present application, there is a capped-opening in the top of each reservoir to refill the fluid. In each reservoir, the supply gas enters at the top, and the fluid is drawn out of the bottom.

The mixing apparatus is a single common application to the plurality of reservoirs. The mixing apparatus is implemented in many ways. The mixing apparatus can use gravity or the force and angle of dispensing from the nozzles and/or the shape of the final container (e.g., cup or glass) for the mixed drink, to mix the fluids. The mixing apparatus can also use the supply gas to aerate the fluid, or if mixing is not necessary, the mixing process is then just used to combine the fluids into one location.

### BRIEF DESCRIPTION OF THE DRAWINGS

FIG. 1 shows an exemplary embodiment of the overall concept in a block representation.

FIG. 2 shows a block representation of an exemplary system having a plurality of reservoirs.

FIG. 3 shows top and side views of an exemplary dispensing system having multiple dispensing nozzles.

FIG. 4 shows top and side views of an exemplary dispensing system having multiple dispensing nozzles and a single dispensing port.

FIG. 5 shows top and center section views of an exemplary reservoir of the system of the invention.

FIG. 6 shows top and center section views of another exemplary reservoir of the invention.

FIG. 7 shows top and center section views of an exemplary mixing apparatus of the invention.

FIG. 8 shows top and center section views of an exemplary dispensing system of the invention.

### DETAILED DESCRIPTION OF EXEMPLARY EMBODIMENTS OF THE INVENTION

The present invention is a mixing and dispensing apparatus made of multiple components. These components include control gas, plurality of control valves, plurality of reservoirs, a mixing apparatus, and a control system. The control gas provides a regulated gas to a single manifold of control valves. This control gas for this particular application is any inert gas with no known harmful effects on humans, such as carbon dioxide, nitrogen, and air. In other applications where human consumption is not an end result, any gas capable of applying pressure to the fluid without interference may be substituted. Implementing a pressurizing fluid in a bladder, or any other means to separate two fluids, to apply a pressure to the fluid in the reservoir may also be used as a control gas. An exemplary but non-limiting application of the systems and methods according to the present invention is to make and deliver mixed drinks, such as those provided at bars or restaurants.

The control valves regulate the flow of supply gas into the reservoirs. In an exemplary embodiment of the present application, these valves are electro-mechanical valves. The control valves allow the supply gas to flow directly into the reservoirs. In another application, a control valve allows the supply gas to flow to a pneumatic pump. The pneumatic pump creates a vacuum on a reservoir pulling the fluid into the pump and then pumping the fluid to the mixing apparatus.

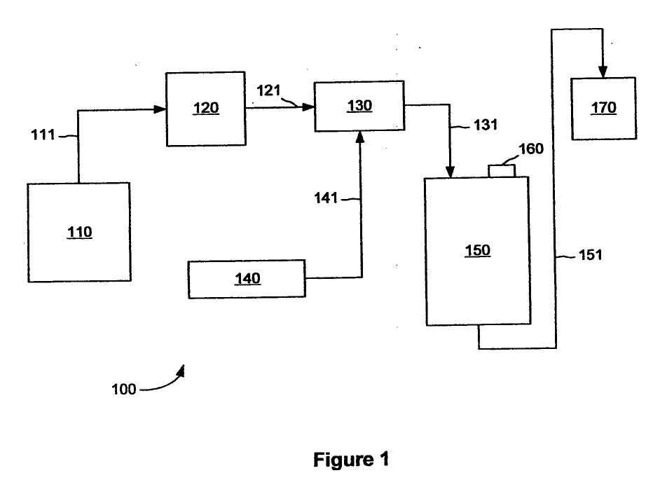

An embodiment of the present invention, as depicted in FIG. 1 and as can be applied to the alcohol industry, is shown as system 100, and is based on pressure pushing fluid for a prescribed time to dispense a specific volume of fluid. The process starts by a user inputting a specific combination of fluids into controller 140. Controller 140 then sends the commands to specific valves on electro-mechanical valve manifold 130 over pathway 141.

Valve manifold 130 connects to the pressure regulator 120 by supply line 121. Pressure regulator 120 controls the force of the supply gas. An exemplary operating range of pressure is from about 0 to about 100 PSI. The pressure regulator 120 connects to a compressed gas supply 110 by supply line 111. A preferred embodiment uses a supply tube large enough to meet the flow requirements of the valve manifold 130. An air compressor may produce the supply gas, thus allowing for a continuous supply of compressed gas for ease of use.

Compressed air flows through the controller-activated valve 130 through supply tube 131 into a specific reservoir 150. Such reservoir 150 may be a stainless steel reservoir and pressurized by the compressed air forcing fluid out from the bottom of a specific reservoir 150 along supply line 151 to the mixer and dispenser 170. The supply line 151 should reach an elevation higher then the maximum fill level of reservoir 150 in order to prevent siphoning. Reservoir 150 may be filled through fill cap 160. Line 151 is the only line to see the stored fluid: all other supply lines carry the supply gas. Blocks 130 and 150 are simplified in FIG. 1.

A mixer, defined as any non-alcoholic liquid can be chosen to dispense alone or combined with an alcohol. A user enters in a drink combination presented on a monitor (not shown) displaying the program written to interface to controller 140. Controller 140 processes the entry and activates specific valves pertaining to that combination. For example, if the selection is “whisky sour,” then controller 140 activates valve 130 connecting supply gas 110 to whiskey reservoir 150. This pressurizes container 150, forcing whiskey out to mixer and dispenser apparatus 170. The sweet and sours mix is added in the same manner, just by activating that specific reservoir. The end result is the whiskey and sweet and sours mix in a cup ready to consume in correct proportions. This process is repeatable, consistent, increases quality, and results in savings in terms of prevention of excessive alcohol loss, an increase in efficiency, and an increase in quantity of served drinks.

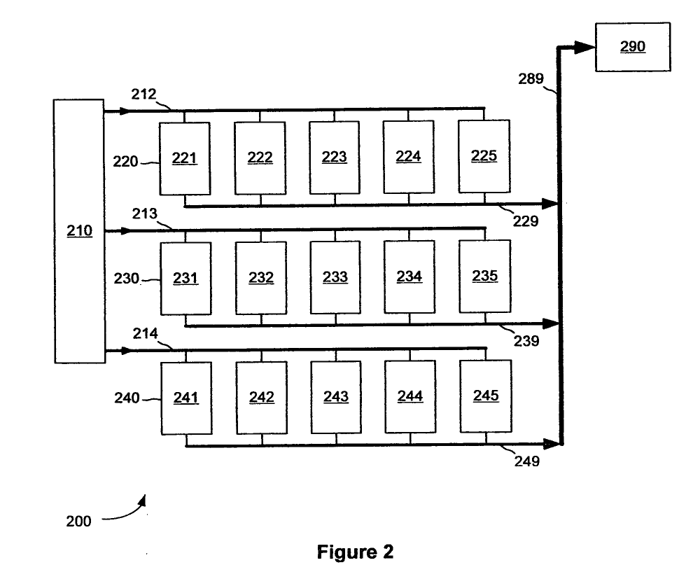

FIG. 2 shows an exemplary embodiment of the present invention as a system 200 having a plurality of valves and reservoirs. In FIG. 2, the multiple reservoirs and valves are shown to illustrate the different combinations of fluids the apparatus can mix and dispense. The same supply gas and controller from FIG. 1 elements 110 and 140, respectively, can operate all valves on the valve manifold 210. Each reservoir has a unique inlet line from valve manifold 210 shown in parallel as supply tubes 212, 213, and 214. Each container 221-225, 231-235 and 241-245 in the plurality of reservoirs in FIG. 2 can contain a different liquor or mixer. Each reservoir also has a unique exit line shown in parallel as exit lines 229, 239, and 249. All individual exit lines, represented in parallel as exit line 289, end at a common mixer and dispenser 290.

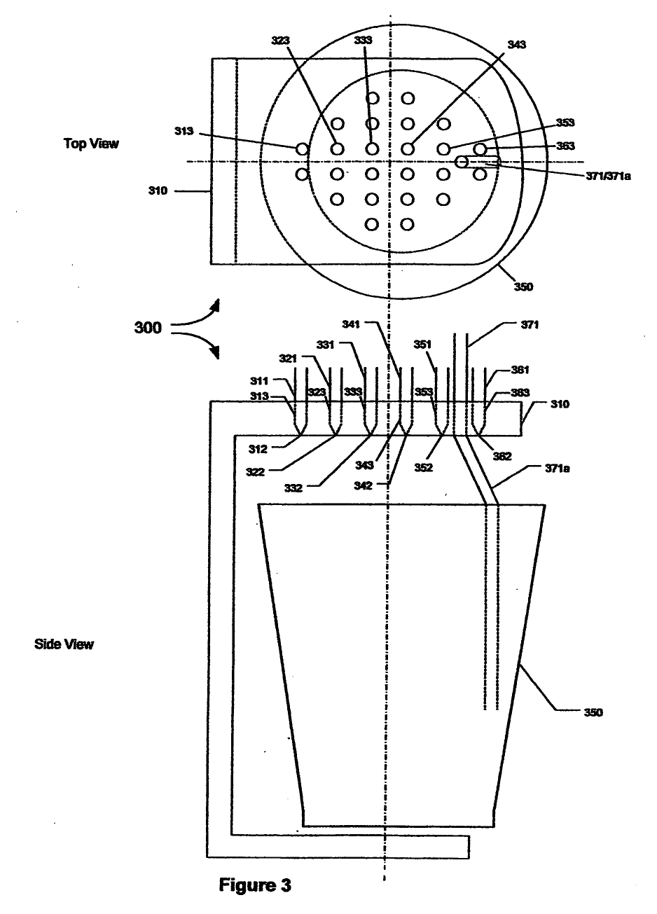

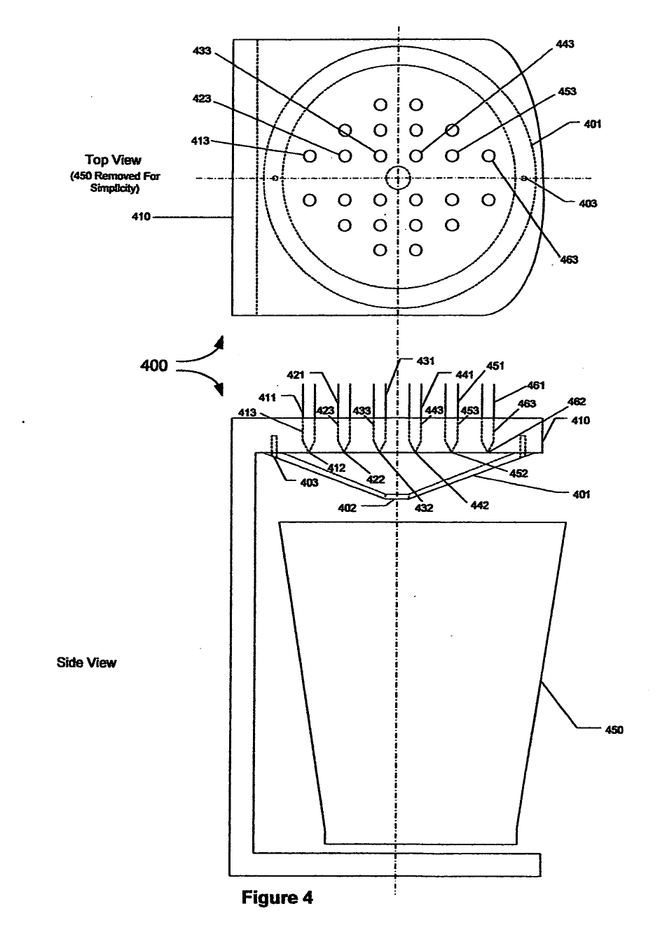

As previously stated above, exemplary exit lines, running in parallel represented as 289 lead to, and terminate directly at, mixer and dispenser 290. Depending on the particular embodiment, the mechanism used to dispense fluid into an awaiting container may differ. FIGS. 3 and 4 are exemplary embodiments of the dispensing system used to deliver fluids into a container.

In FIG. 3, a dispensing system 300 is shown that directs fluid traversing through nozzle support 310 into container 350. In this particular embodiment, exit lines 311,321, 331, 341, 351, and 361 connect to nozzles 313, 323, 333, 343, 353, and 363, respectively, which terminate at ports 312, 322, 332, 342, 352, and 362, respectively, such that each type of fluid carried by each exit line terminating at each port directly dispenses into container 350. Element 371 is a line dedicated for delivery of a gas, such as air or carbon dioxide. Delivery of a gas can be used to dry or blow clean a container before filling, mix a drink after dispensing, or for any other purpose. Line 371, which is depicted in FIG. 3 only, but can be applied to any of the various embodiments of the invention, traverses nozzle support 310 either by passing through nozzle support 310 or by connecting to support 310 at the top and bottom of support 310, resulting in a two-piece line comprising lines 371 and 371a. Line 371 can be flexible, either throughout its entirety or, if a two part line is used, only at one portion, preferably at portion 371a. A flexible line 371 permits the user to easily move the line into and out of a container, before or after filling. One advantage of this type of system is the ease in replacing faulty exit lines and the minimization of cross-contamination of one fluid into another. The number of ports on nozzle support 310 will be dependent on the number of reservoirs. Only four exit lines and four respective ports have been shown in the side view for sake of simplicity—other nozzles are depicted, but not labeled, in the top view drawing to show that the nozzle support 310 may accommodate numerous nozzles.

FIG. 4 shows an exemplary embodiment of a system 400 comprising a nozzle combination according to the present invention. In this figure, a dispensing system 400 includes a nozzle support 410 that has multiple exit lines 411, 421, 431, 441, 451, and 461 leading to and terminating into it. At nozzle support 410, exit lines 411,421,431, 441,451, and 461 connect to nozzles 413, 423, 433, 443, 453, and 463, respectively, which terminate at ports 412, 422, 432, 442, 452, and 462, respectively, such that each type of fluid carried by each exit line terminating at each port dispenses into nozzle 401. Nozzle 401 has a dispensing port 402 that serves as the only source of fluid flow into container 450. Nozzle 401 is secured to nozzle support 410 at connecting point 403, allowing removal of nozzle 401 for cleaning purposes. An advantage of this type of system is the simplicity in design and components, which leads to minimized costs associated with replacement and upgrade of particular components. However, because of the mixing of fluids in nozzle 401 before the dispensing of the mixed fluid out of port 402, there is a greater risk of cross-contamination in this system than that of system 300 described with respect to FIG. 3 above.

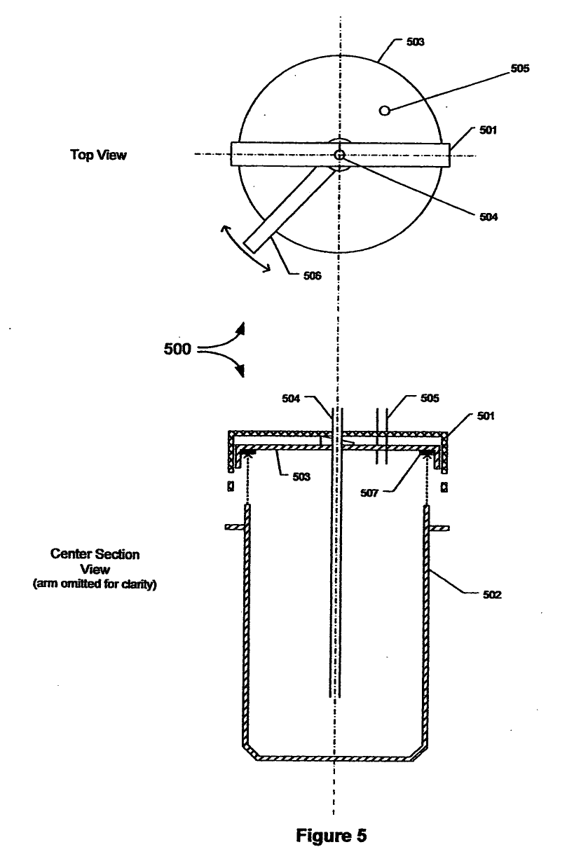

In another exemplary embodiment, FIG. 5 represents a reservoir 500 for storing fluids. The fluid is stored in removable section 502. A user removes section 502 to modify fluid in that particular reservoir. Section 502 slides into section 503 so that the tabs on section 502 enter the “L” slot located on bracket 501. Section 503 is the mounted or secured section of the reservoir. When section 502 is inside section 503, lever 506 is adjusted to raise bracket 501 and pull section 502 against gasket 507 in section 503 causing a tight seal. Lever 506 is located between bracket 501 and section 503 and is ramped to force bracket 501 away from section 503 when adjusted. Supply line 505 connects reservoir described in FIG. 5 to valve manifold 130 (FIG. 1). Exit line 504 draws fluid from the bottom of section 502 through section 503 and section 501. Each exit line 504 leads to the mixer and dispenser seen as 290 in FIG. 2.

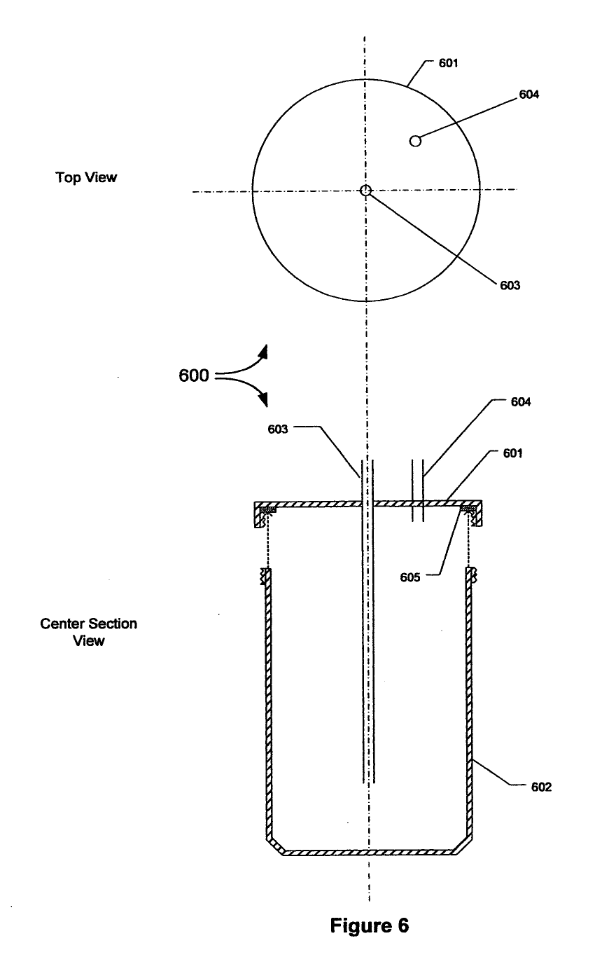

Another model of a particular type of reservoir is shown as structure 600 in FIG. 6. FIG. 6 comprises a removable section 602. The fluid is stored in the removable section 602. Therefore, when the fluid is empty and needs refilling, the user unscrews section 602 and fills the bottom removable part of the reservoir to the fill limit. The user then screws section 602 into a mounted section 601 against gasket 605. Section 601 is the mounted or secured section of the reservoir. This piece comprises a supply tube 604, exit line 603, and gasket 605. Supply line 604 connects reservoir described in FIG. 6 to valve manifold 130 (see FIG. 1). Exit line 603 draws fluid from the bottom of section 602 through the mounted section 601. Each exit line 603 leads to the mixer and dispenser seen as 290 in FIG. 2.

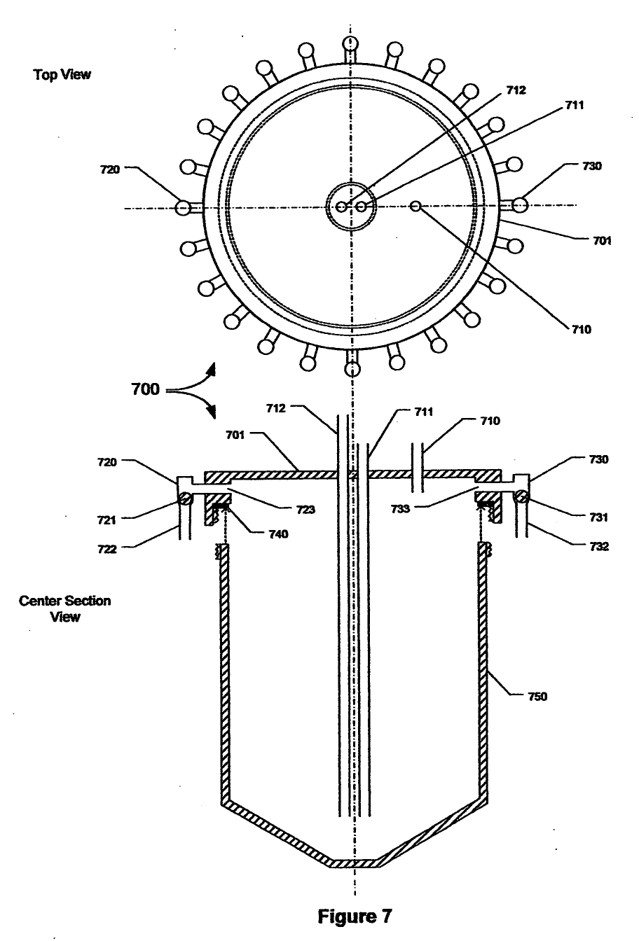

FIG. 7 depicts an exemplary embodiment of a mixing apparatus 700. The objective of this mixing apparatus is combine all of the exit lines, such as line 504 from FIG. 5, into one location for mixing before exiting the machine into the dispensing apparatus. Exit lines from all reservoirs are shown as entrance line 722 in FIG. 7. There are at least as many entrance lines as there are reservoirs; although, in this embodiment, there are more entrance lines 722 then reservoirs. This is to allow for upgrades and additions to the overall system. When the embodiment is at a resting state, object 721 is set into the line to seal entrance line 722. Object 721 is possibly many different materials. It could be a stainless steel ball that is of slightly larger diameter then entrance line 722. It could also be made out of a polymer that floats. This would allow for the object to rest on top of the fluid. When the mixing apparatus is in use, the fluid pumps to the mixing apparatus, up entrance line 722 displacing object 721 upwards causing object 721 to float on top of the fluid into void 720. The fluid flows past object 721 and flows into tube 723. Tube 723 is almost perpendicular to entrance tube 722. It is at a slight angle sloping towards the mixing reservoir 750. The mixing reservoir 750 is where tube 723 ends. Once the total volume of fluid is in the mixing reservoir for that particular recipe, then the supply of the fluid halts causing gravity to replace object 721 at its resting state inside entrance tube 722. The mixing reservoir is the delivery location for all entrance tubes 722 flowing into tube 723. Here, one fluid at a time combines into mixing reservoir 750. Each fluid enters in through a different entrance line, as there is one entrance line per fluid, which is stored in a reservoir as seen in FIG. 5. Once all individual fluids for that particular recipe are in mixing reservoir 750, aeration line 711 activates. This causes a stream of supply gas to aerate the contents of reservoir 750 creating a well mixed combination of fluids. Aeration line 711 connects to the valve manifold 130 in FIG. 1 using a two-way valve. The valve is normally closed. When mixing completes, supply line 710 activates causing the mixing reservoir to pressurize. This also seats all object 721 securely into place inside entrance line 722. Supply line 710 is also connected to the valve manifold using a valve. Once the supply line 710 pressurizes the mixing reservoir, the fluid expels through exit line 712 to the dispenser. A built in, automatic flush system provides a system to maintain high standards of drinks. Entrance line 732, object 731, void 730, and tube 733 all act in the same manor as entrance line 722, object 721, void 720, and tube 723. This line represents a water line. This water line activates after a mixed drink is completely out of the embodiment. It fills the mixing reservoir 750, aeration line 711 creates a method to clean the reservoir, and then the water flows to the dispenser. This procedure removes remnants of the last drink made in the mixing apparatus. Also, mixing reservoir 750 unscrews from a permanent mounting piece 701. This allows for any ease of maintenance, and additional cleaning. The mixing reservoir 750 seals against gasket 740 when in place.

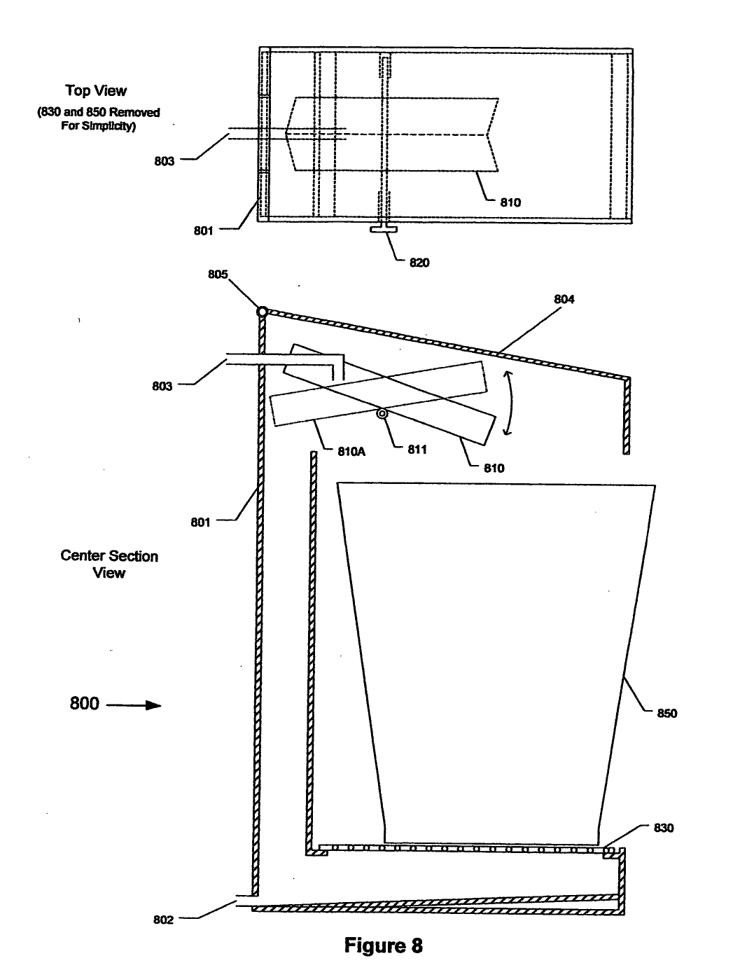

FIG. 8 depicts an exemplary embodiment of a dispensing apparatus 800. The mixing apparatus divides into two main parts. The delivery of a mixed drink is the first part. In FIG. 8, entrance tube 803 delivers the mixed drink from a mixing apparatus, like the one described in FIG. 7, to the dispensing apparatus. Entrance tube 803 drains the fluid onto “V” shaped channel 810. Channel 810 then drains into glass 850 resting on 830, a removable drainage grate. Below drainage grate 830 is a sloping shoot leading to waste tube 802. The second major part of the dispensing unit is the delivery of a cleaning fluid after the mixed drink has exited and is in glass or cup 850. The cleaning fluid, such as water, enters from the mixing apparatus, which was also cleaned, into the dispensing apparatus by entrance tube 803. Before the fluid gets to the end of entrance tube 803, channel 810 is pivoted on pivoting point 811 into position 810A. This allows the cleaning fluid to rinse entrance tube 803 and channel 810, and then fall along wall 801 into the drainage shoot leading to waste tube 802 without ever being seen by the user. Pivot control arm 820 controls pivoting point 811. A power source, such as an electric solenoid or a pneumatic cylinder, energizes pivot control arm 820. In order to make the apparatus easy to clean and maintain, top section 804 attaches to wall 801 by one or more hinges 805 in order to move the top section up and down.

Thus it can be seen that in certain embodiments, the invention provides an automated fluid dispensing device comprising: a mixer that collects at least one fluid and direct it into a final removable container; at least one reservoir to store a certain volume of at least one fluid, wherein the fluid is dispensed by creating a pressure drop moving the fluid into the mixer; a source of pressure in fluid communication with the reservoir; a single valve positioned between the source of pressure and the reservoir; and a control circuit to monitor the amount of time that the source of pressure is in contact with the reservoir through control of the valve to direct fluid to the mixer from the reservoir. The fluid can be any fluid of interest to the user, but is typically a fluid that can be consumed, such as water, a beverage that is carbonated or can be carbonated through the action of the device, an alcoholic beverage, or a liquid that is typically combined with an alcohol-containing liquid to create an alcoholic beverage. As should be evident, the mixer is any device or combination of elements that can bring about mixing of two or more liquids to create a single liquid containing the original liquids. It preferably provides a homogeneous composition, but does not necessarily do so. It furthermore may be used in conjunction with a single liquid, in which case the mixer, while capable of mixing two or more liquids, in fact does not perform that function. In certain embodiments, the device does not comprise a valve positioned between the mixer and the final removable container, unlike known devices for mixing and dispensing fluids. Furthermore, in certain embodiments, movement of the fluid(s) from the reservoir to the final container proceeds essentially completely through the pressure supplied by the source of pressure. In other words, dispensing occurs without significant assistance from the force of gravity. Of course, it is never possible to completely eliminate the force of gravity as an effect on any physical activity in normal daily life; however, unlike many devices in this field, the device of the present invention does not rely to any significant extent on the force of gravity to dispense a liquid into the final container. As should be evident from the above disclosure, in embodiments, the device can comprise two or more reservoirs containing two or more different fluids, such as, but not limited to, water and a liquor, a syrup for a carbonated beverage and a liquor, two different syrups for two different carbonated beverages, or a combination of any two or more of these. In yet other exemplary embodiments, the device can comprise two or more reservoirs, each independently containing the same or a different fluid than one or more of the other reservoirs.

It can also be seen that, in certain embodiments, the invention provides an automated fluid dispensing device comprising: a mixer that collects at least one fluid and direct it into a final removable container; at least one reservoir to store a certain volume of at least one fluid, wherein the fluid is dispensed by creating a pressure drop moving the fluid into the mixer; a source of pressure in fluid communication with the reservoir; a single valve positioned between the source of pressure and the reservoir; and a control circuit to monitor the amount of time that the source of pressure is in contact with the reservoir through control of the valve to direct fluid to the mixer from the reservoir, where the device does not comprise a valve positioned between the mixer and the final removable container, and where essentially all of the force used to deliver at least one fluid from at least one reservoir is supplied by the source of pressure, which is not gravity. In preferred embodiments, the force used to deliver all of the fluids contained in all of the reservoirs is supplied by the source of pressure. The source of pressure in this embodiment and the one discussed immediately above can be any source of pressure that is suitable, including but not limited to those discussed above. In particular embodiments, the device can comprise two or more reservoirs capable of supplying fluids to a single mixer, where the mixer combines the fluids transferred from the reservoirs and dispenses the resulting combination of fluids into a removable container. It is preferred in all embodiments that some or all of the materials that come in contact with a fluid when the device is in operation are not significantly degraded by contact with liquids containing ethanol or having a low pH (below pH 5.0). For example, it is preferred that these materials be made of steel, stainless steel, a polymeric plastic material, or the like.

Further advantages of various embodiments of the invention are to reduce costs associated with frequent cleaning and replacing of the various components of the system. An advantage of exemplary embodiments of the present invention is that the components used are individually separable and replaceable without disruption of the rest of the system. Another advantage of the system is that fewer parts and components are used as compared to conventional mixing and dispensing systems. Yet a further advantage is that the precise volume of each ingredient of a given drink is measured and dispensed according to a predetermined recipe, thereby making the resultant end product consistent. Another advantage of the system is the flexibility of placing such a system and its components anywhere within a bar system, without consideration as to the effects of gravity or the like.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the principles of the invention in their broader aspects may be applied to other fluid mixing and/or dispensing systems such as paint or food. The scope of the invention is to be defined only by the claims appended hereto, and by their equivalents.

Further, in describing representative embodiments of the present invention, the specification may have presented a method and/or process of the present invention as a particular sequence of steps. However, to the extent that a method or process does not rely on the particular order of steps set forth herein, the method or process should not be limited to the particular sequence of steps described. As one of skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. An automated fluid mixing and dispensing device comprising:
a mixing apparatus that collects several different fluids and directs them into a final removable container containing the desired product;
a reservoir to store a certain volume of fluid, wherein the fluid is dispensed by creating a pressure drop moving the fluid into the mixing apparatus;
a source of pressure in fluid communication with the reservoir;
a valve positioned between the source of pressure and the reservoir; and
a control circuit to monitor the amount of time that the source of pressure is in contact with the reservoir through control of the valve to direct fluid to the mixing apparatus from the reservoir.

2. The device of claim 1, further comprising a plurality of reservoirs, each containing a fluid, wherein the control circuit activates the specific valve for the specific reservoir, the pressurization causing that particular fluid to transfer to the mixing apparatus.

3. The device of claim 1, further comprising a plurality of reservoirs supplying fluids to a common mixing apparatus, wherein the mixing apparatus combines the fluids transferred from the reservoirs and dispenses the resulting fluid made of a combination of fluids stored in the reservoirs into a removable container.

4. The device of claim 1, further comprising a plurality of control valves controlling a plurality of reservoirs to provide individual pressurization, wherein each control valve is an electro-mechanical valve with a common gas manifold such that the control valve allows regulated gas to charge the reservoir, pushing fluid from the reservoir delivering the fluid to the mixing apparatus.

5. The device of claim 4, wherein the plurality of control valves can activate a pump to pull fluid from the reservoirs delivering the fluid to the mixing apparatus.

6. The device of claim 1, further comprising a control system to activate the control valves, wherein the control system maintains various time elements and various combinations of fluids and wherein the control system activates the specific control valves to specific reservoirs for specific amounts of time based in a predetermined recipe mixture.

7. The device of claim 6, wherein the time element of the control system is specific to each reservoir, wherein time element is based upon various properties of the fluid and the transport system.

8. The device of claim 7, wherein the properties of the fluid include, but are not limited to, viscosity, temperature, elevation, and density.

9. The device of claim 7, wherein the properties of the transport system include, but are not limited to, friction loss, length of the transport system, and gravity affects.

10. An automated fluid dispensing device comprising:
a mixer that collects at least one fluid and direct it into a final removable container;
at least one reservoir to store a certain volume of at least one fluid, wherein the fluid is dispensed by creating a pressure drop moving the fluid into the mixer;
a source of pressure in fluid communication with the reservoir;
a single valve positioned between the source of pressure and the reservoir; and
a control circuit to monitor the amount of time that the source of pressure is in contact with the reservoir through control of the valve to direct fluid to the mixer from the reservoir.

11. The device of claim 10, wherein the device does not comprise a valve positioned between the mixer and the final removable container.

12. The device of claim 10, wherein movement of the at least one fluid from the reservoir to the final container proceeds essentially completely through the pressure supplied by the source of pressure.

13. The device of claim 10, wherein the device comprises two or more reservoirs containing two or more different fluids.

14. The device of claim 13, wherein at least one of the fluids contains alcohol.

15. The device of claim 10, wherein the device comprises two or more reservoirs, each independently containing the same or a different fluid than one or more of the other reservoirs.

16. The device of claim 10, comprising at least one reservoir containing an alcoholic fluid.

17. An automated fluid dispensing device comprising:
a mixer that collects at least one fluid and direct it into a final removable container;
at least one reservoir to store a certain volume of at least one fluid, wherein the fluid is dispensed by creating a pressure drop moving the fluid into the mixer;
a source of pressure in fluid communication with the reservoir;
a single valve positioned between the source of pressure and the reservoir; and
a control circuit to monitor the amount of time that the source of pressure is in contact with the reservoir through control of the valve to direct fluid to the mixer from the reservoir,
wherein the device does not comprise a valve positioned between the mixer and the final removable container, and
wherein essentially all of the force used to deliver at least one fluid from at least one reservoir is supplied by the source of pressure, which is not gravity.

18. The device of claim 17, comprising two or more reservoirs capable of supplying fluids to a single mixer, wherein the mixer combines the fluids transferred from the reservoirs and dispenses the resulting combination of fluids into a removable container.

19. The device of claim 17, wherein all of the materials that come in contact with a fluid when the device is in operation are not significantly degraded by contact with liquids containing ethanol or having a low pH.

20. The device of claim 19, wherein the materials that come into contact with a fluid when the device is in operation are made of steel, stainless steel, or a polymeric plastic material.
